(19) United States
(12) Patent Application Publication
(10) Pub. No.: US 2026/0364514 A1
(43) Pub. Date: Nov. 19, 2026

(54) Modular CO2 Adsorption Device for Separating CO2 from an Air Flow which is Fed in by Means of an Adsorption/Desorption Process

(71) Applicant: Robert Bosch GmbH, Stuttgart (DE)

(72) Inventors: Friedrich Kneule, Rutesheim (DE); Harald Bauer, Ehningen (DE)

(21) Appl. No.: 19/141,193

(22) PCT Filed: Nov. 27, 2023
(86) PCT No.: PCT/EP2023/083101

§ 371 Date: Jun. 19, 2025

(30) Foreign Application Priority Data
Dec. 21, 2022 (DE) 10 2022 214 124.5

(51) Int. Cl. B01D 53/04

(52) U.S. Cl. CPC B01D 53/0446; B01D 53/0438; B01D 53/0454; B01D 2257/504; B01D 2259/40096

(57) ABSTRACT

A modular CO2 adsorption device for separating CO2 from a supplied air flow by way of an adsorption/desorption process is disclosed, which has an adsorption chamber module and at least one adsorption fan module. The adsorption fan module is fastened releasably on an outer side of a freight container outer wall of a freight container of the adsorption chamber module.

### PRIOR ART

The invention relates to an adsorption chamber module for a modular CO2 adsorption device, an adsorption fan module for a modular CO2 adsorption device, and a modular CO2 adsorption device for separating CO2 (carbon dioxide) from a supplied air flow by means of an adsorption-desorption process. The invention further relates to a use of an adsorption chamber module and/or an adsorption fan module and/or a modular CO2 adsorption device for separating CO2 from a supplied air flow, as well as a method for manufacturing an adsorption chamber module and a method for transporting a modular CO2 adsorption device.

WO 2020/212146 A1 discloses a direct air capture (DAC) system with a freight container in which all essential technical components are arranged within the freight container in order to comply with the external dimensions of the ISO 668 standard for freight containers. Although the arrangement of the technology in the main dimensions of ISO 668 allows for easy transport, it considerably reduces the available space for the adsorption-desorption chamber, i.e. the “reaction space” for the adsorption-desorption process. Furthermore, in the event of technical faults, the entire complex freight container must be repaired. Different sizes can only be operated by redesigning the system.

### DISCLOSURE OF THE INVENTION

The subject of the present invention is an adsorption chamber module for a modular CO2 adsorption device for separating CO2 from a supplied air flow by means of an adsorption-desorption process, with
a freight container that functions as a chamber module housing, which is designed in particular according to ISO 668,
an adsorption-desorption chamber arranged in the freight container for receiving an adsorbent for adsorbing the CO2 from the supplied air flow,
an inlet duct for supplying the air flow into the adsorption-desorption chamber, and
an outlet duct for discharging the CO2-reduced air flow from the adsorption-desorption chamber,
   wherein the freight container has a receiving unit for the releasable fastening of at least one adsorption fan module of the modular CO2 adsorption device to an outer side of a freight container outer wall, in order to guide the air flow by means of a fan unit of the adsorption fan module via the inlet duct into the adsorption-desorption chamber.

The present invention further relates to an adsorption fan module for a modular CO2 adsorption device for separating CO2 from a supplied air flow by means of an adsorption-desorption process, with
a fan module housing, and
a fan unit arranged in the fan module housing for supplying the air flow into an adsorption-desorption chamber for receiving an adsorbent for adsorbing the CO2 from the supplied air flow, wherein the adsorption-desorption chamber is arranged in a freight container, in particular according to ISO 668, of an adsorption chamber module of the modular CO2 adsorption device,
   wherein the fan module housing has an engagement unit for the releasable fastening of the adsorption fan module to an outer side of a freight container outer wall, in order to guide the air flow by means of the fan unit via an inlet duct of the adsorption chamber module into the adsorption-desorption chamber.

The present invention also relates to a modular CO2 adsorption device for separating CO2 from a supplied air flow by means of an adsorption-desorption process, with an adsorption chamber module as described above and at least one adsorption fan module as described above.

The present invention also relates to the use of a previously described adsorption chamber module and/or a previously described adsorption fan module and/or a previously described modular CO2 adsorption device for separating CO2 from an incoming air flow.

The subject of the present invention is also a method for producing an adsorption chamber module for a modular CO2 adsorption device for separating CO2 from a supplied air flow by means of an adsorption-desorption process, in particular of the type described above, comprising the steps of:
provision of a freight container, which is particularly designed according to ISO 668, as a chamber module housing,
forming an adsorption-desorption chamber in the freight container to receive an adsorbent for adsorbing the CO2 from the incoming air flow,
forming an inlet duct for supplying the air flow into the adsorption-desorption chamber,
forming an outlet duct to discharge the CO2-reduced air flow from the adsorption-desorption chamber, and
forming a receiving unit on the freight container for the releasable fastening of at least one adsorption fan module of the modular CO2 adsorption device to an outer side of a freight container outer wall, in order to guide the air flow by means of a fan unit of the adsorption fan module via the inlet duct into the adsorption-desorption chamber.

The present invention further comprises a method for transporting a modular CO2 adsorption device as described above for separating CO2 from an incoming air flow by means of an adsorption-desorption process, wherein the at least one adsorption fan module is arranged in the adsorption-desorption chamber for transportation purposes, so that the external dimensions of the adsorption chamber module's freight container remain unchanged during transportation.

The modular CO2 adsorption device according to the invention offers the considerable advantage, due to the modularity, i.e. the separation into an adsorption chamber module and an adsorption fan module, offers the considerable advantage that the size and volume of the adsorption-desorption chamber and thus of the “reaction space”, which is crucial for the amount of adsorbable CO2 from the supplied air flow per container volume, can be maximized. In this way, the external dimensions of the freight container (e.g. according to ISO 668) can be adhered to for transportation and at the same time, by “outsourcing” the voluminous fan unit into a separate adsorption fan module—which can be releasably fastened on the outer side of the freight container outer wall only on site (outside the main dimensions of ISO 668)—a much larger volume of the freight container can be used as an adsorption-desorption chamber for the adsorber material to be cycled. Thus, the specific investment [EUR_adsorber technology/kg_adsorber material] can be significantly reduced.

Furthermore, the effort involved in the manufacturing process can be greatly reduced by separating it into a simple container steel structure on the one hand and a technology from mass production on the other. Furthermore, in the event of technical faults, only the adsorption fan module needs to be repaired or replaced. Flexibility is also increased for different freight container sizes, as the adsorption fan modules can be manufactured in different sizes and/or performance classes, while the receiving unit and the engagement unit can remain unchanged.

In the context of the present invention, the term “separation” comprises a separation, e.g. removal of CO2 (carbon dioxide) from the air.

In the context of the present invention, the term “supply” or “supplied” comprises an actively performed or initiated and thus technically controlled or regulated supply of air flow by means of a fan unit.

The modular CO2 adsorption device according to the invention is designed to separate CO2 from an incoming air flow by means of an adsorption-desorption process, i.e. an adsorption-desorption process that can or is carried out cyclically. The basic functioning of the modular CO2 adsorption device and/or the cyclically performed adsorption-desorption process can be analogous to, for example, WO 2015/185434A1. For this purpose, the modular CO 2 adsorption device has an adsorption chamber module according to the invention and at least one adsorption fan module according to the invention.

The adsorption chamber module is designed and constructed to separate CO2 from an incoming air flow by means of an adsorption-desorption process in a modular CO2 adsorption device.

For this purpose, the adsorption chamber module has a freight container that functions as a chamber module housing. Freight containers are also known as ISO containers. The freight container is preferably designed as an ISO container according to ISO 668.

The freight container can preferably have a grid size of less than or equal to 8″ width, as small 8″ units can be easily combined with 40″ and/or 48″ containers with several units for a free-standing installation for larger separation rates, for example in the form of building integration, i.e. for removing CO2 from room air when the container is installed in the air conditioning region of the building.

An adsorption-desorption chamber is arranged or formed in the freight container, i.e. within the external dimensions or dimensions of the freight container. The adsorption-desorption chamber is designed and equipped to receive an adsorbent for the adsorption of CO2 from the supplied air flow. In the adsorption-desorption chamber, an adsorbent (suitably functionalized) can be arranged for adsorption, i.e. for binding or filtering the CO2 from the supplied air flow, for example in the form of CO2 adsorption modules.

The adsorption chamber module also has an inlet duct for supplying the air flow into the adsorption-desorption chamber and an outlet duct for discharging the CO2-reduced air flow from the adsorption-desorption chamber. The inlet and outlet ducts are arranged in the freight container, i.e. within the external dimensions or dimensions of the freight container.

The freight container has a receiving unit. The receiving unit is designed such that at least one adsorption fan module of the modular CO2 adsorption device can be releasably fastened to an outer side of a freight container outer wall in order to guide the air flow into the adsorption-desorption chamber via the inlet duct by means of a fan unit of the adsorption fan module. In the case of the freight container outer wall, this is preferably a side, i.e. transverse/front or longitudinal freight container outer wall.

Accordingly, the receiving unit can be arranged on at least one transverse side or transverse freight container outer wall and/or at least one longitudinal side or longitudinal freight container outer wall, so that the at least one adsorption fan module can be releasably fastened to the respective side. However, the receiving unit can also be arranged on an upper freight container outer wall, to which the adsorption fan module can be releasably fastened in such a way that it is arranged on the transverse or longitudinal side.

The receiving unit is advantageously designed to form a releasable, form-fitting connection with the at least one adsorption fan module, in particular an engagement unit of the at least one adsorption fan module.

It is also advantageous if the receiving unit has at least one load-receiving region on the outer side of the freight container outer wall, on and/or on which the at least one adsorption fan module can be hooked, placed and/or fixed for releasable fastening. In this case, it is advantageous if the load-receiving region has at least one lower load-receiving point, in particular two lower load-receiving points, on which the adsorption fan module can be placed, and/or at least one upper load-receiving point, in particular two upper load-receiving points, on which the adsorption fan module can be fixed. In other words, for installation and operation, the adsorption fan module can be held in position on the freight container outer wall by means of the receiving unit, e.g. at the bottom (but also at the top), by form fit (protection against falling out or down, earthquake protection, etc.) and secured at the top by tilting or sliding over bolts and/or other connecting elements. In this context, the terms “top” and “bottom” refer to the intended positioning or orientation of the freight container.

It is also advantageous if the receiving unit has at least one bearing element for movable, in particular rotatable and/or pivotable and/or slidable mounting of the at least one adsorption fan module on the outer side of the freight container outer wall. For this purpose, the receiving unit can, for example, have a hinge and/or a joint and/or a rail or parts thereof.

It is also advantageous if the adsorption-desorption chamber is designed to at least partially, in particular completely, accommodate the at least one adsorption fan module for transportation purposes, so that the external dimensions or dimensions of the freight container remain unchanged during transportation. In this case, it is advantageous if the adsorption-desorption chamber has a correspondingly dimensioned, in particular lockable opening, through which the at least one adsorption fan module can be introduced into the adsorption-desorption chamber and removed from it again. In other words, the adsorption-desorption chamber is preferably dimensioned so that the adsorption fan module can be arranged in it and the adsorption fan module can optionally also be transported within the dimensions of the freight container, so that the standard dimensions of the freight container remain unchanged during transportation and the adsorption fan module can be fastened releasably on the outer side of the freight container outer wall only at the installation site, for example.

Advantageously, the adsorption chamber module also has at least one fluidic connection for the fluidic connection of the at least one adsorption fan module which can be fastened or is fastened releasably. In this case, in particular a fan unit of the at least one adsorption fan module can be or can be connected by means of the fluidic connection to the inlet duct of the adsorption chamber module and/or a temperature control unit of the at least one adsorption fan module can be or can be connected to a temperature control line of the adsorption chamber module and/or a pump unit of the at least one adsorption fan module can be or can be connected to a pressure connection of the adsorption chamber module for the desorption process. At least one fluid connection is preferably arranged in the freight container, i.e. within the external dimensions or dimensions of the freight container.

In other words, the adsorption chamber module preferably has a temperature control line for controlling the temperature of the adsorbent for the adsorption-desorption process, with a corresponding fluidic connection, wherein the fluidic connection to the at least one adsorption fan module, which can be fastened or is fastened releasably, can be connected or is connected in terms of fluidics. Alternatively or additionally, the adsorption chamber module preferably has a pressure connection for providing an overpressure and/or underpressure for the desorption process, wherein the fluidic connection to the at least one adsorption fan module, which can be fastened or is fastened releasably, is fluidically connectable or connected.

The adsorption chamber module may also comprise at least one of the following units, which are located in the freight container, i.e. within the external dimensions or dimensions of the freight container: Temperature control unit for controlling the temperature of the adsorbent for the adsorption-desorption process by means of the temperature control line; pump unit for providing the overpressure and/or underpressure for the desorption process at the pressure connection; closing unit for opening and/or closing the inlet duct and/or the outlet duct; drive unit for components to be moved, in particular closing elements of the closing unit; sensor unit for the adsorption-desorption process; control unit for controlling and/or regulating the adsorption-desorption process; energy supply unit and/or energy generation unit for the adsorption-desorption process.

It should be noted that the adsorption chamber module preferably has no fan unit for supplying air flow to the adsorption-desorption chamber.

Advantageously, the adsorption chamber module also has at least one electrical connection, in particular an electrical plug-in connection, for the electrical connection of the at least one adsorption fan module that can be fastened or is fastened releasably.

In a further training course, the adsorption chamber module for desorption has a pump device for providing the underpressure, as well as an electrical connection for the electrical heating of the adsorber material.

The adsorption fan module is designed and constructed to supply an air flow for the adsorption-desorption process in a modular CO2 adsorption device.

For this purpose, the adsorption fan module has a valve housing and a fan unit. The fan unit is designed and set up to direct the air flow into an adsorption-desorption chamber for receiving an adsorbent for the adsorption of the CO2, the adsorption-desorption chamber being arranged in a freight container of an adsorption chamber module of the modular CO2 adsorption device.

The fan unit is located in the fan module housing. In this case, the fan unit does not have to be completely inside, i.e. within the dimensions of the fan module housing. The fan unit can have one or more fans.

The fan module housing has an engagement unit. The engagement unit is designed to fasten releasably the adsorption fan module to the outer side of a freight container outer wall in order to guide the air flow through the fan unit via an inlet duct of the adsorption chamber module into the adsorption-desorption chamber.

The engagement unit is advantageously designed to form a releasable, form-fitting connection with the adsorption chamber module, in particular a receiving unit of the adsorption chamber module.

It is also advantageous if the engagement unit is designed for releasable fastening, to be hung and/or placed and/or fixed on the outer side of the freight container outer wall on at least one load-receiving region. In other words, the engagement unit is preferably designed to be hooked and/or placed and/or fixed onto a correspondingly designed load-receiving region on the outer side of the freight container outer wall.

In this case, the engagement unit is advantageously designed for releasable fastening, to be placed on at least one lower load-receiving point, in particular two lower load-receiving points, of the load-receiving region, and/or to be fixed to at least one upper load-receiving point, in particular two upper load-receiving points, of the load-receiving region.

Furthermore, it is advantageous if the engagement unit has at least one bearing element for movable, in particular rotatable and/or pivotable and/or slidable mounting on the outer side of the freight container outer wall. For this purpose, the engagement unit can, for example, have a hinge and/or a joint and/or a guide element or parts thereof.

Advantageously, the fan unit also has at least one of the following units, which is/are arranged in and/or on the fan module housing: Temperature control unit for controlling the temperature of the adsorbent for the adsorption-desorption process; pump unit for providing an overpressure and/or underpressure for the desorption process; closing unit for opening and/or closing the inlet duct and/or the outlet duct; drive unit for components to be moved, in particular closing elements of a closing unit; sensor unit for the adsorption-desorption process; control unit for controlling and/or regulating the adsorption-desorption process; energy supply unit and/or energy generation unit for the adsorption-desorption process.

The adsorption fan module preferably has at least one fluidic connection for fluidic connection to the adsorption chamber module. In this case, the fan unit can be connected to the inlet duct of the adsorption chamber module and/or the temperature control unit can be connected to a temperature control line of the adsorption chamber module and/or the pump unit can be connected to a pressure connection of the adsorption chamber module for the desorption process by means of the fluid connection.

The temperature control unit may include a heat pump and/or an electric heater.

The closing unit is designed to open and/or close the inlet and/or outlet duct and thus the adsorption-desorption chamber depending on the process. In this case, the closing unit can comprise one or more valves. The closing unit can have an inlet valve which is arranged in the inlet duct for the sucked-in air flow and is designed to open and/or close the inlet duct and thereby isolate the adsorption-desorption chamber upstream. The closing unit can also have an outlet valve which is arranged in the outlet duct for the CO2-reduced air flow and is designed to open and/or close the outlet duct and to close the adsorption-desorption chamber downstream. The closing unit can also have a CO2 valve, which is arranged in a CO2 outlet duct of the adsorption-desorption chamber and is designed to open and/or close a CO2 outlet duct in order to bound/filtered and then desorbed, i.e. released CO2 out of the adsorption-desorption chamber in a targeted manner. The closing unit can also be designed to close the freight container outer wall by means of closing elements, for example, rotatable flaps and/or slats, so that the fan unit forms a closed wall section of the freight container outer wall, in particular for the desorption process. The closing unit can also have one or more doors, in particular sliding doors, as closing elements.

The control unit can be designed to be connected to other control units and/or a central control unit by means of radio transmission such as W-LAN, Bluetooth, Near-Field Communication etc.

The adsorption fan module can also understandably have further components, such as components for the generation and/or distribution of a desorption gas (e.g. water vapor) and/or separating elements (e.g. liquid traps).

Advantageously, the adsorption fan module also has at least one electrical connection, in particular an electrical plug-in connection for electrical connection to the adsorption chamber module.

It is advantageous if several fan modules can be directly coupled to one another, either electrically or fluidically. In particular, fan modules that can be fastened to the same freight container and have connections for power or fluids, so that additional lines can be avoided.

It is also advantageous if the at least one adsorption fan module is releasably fastened on the outer side of the freight container outer wall of the adsorption chamber module's freight container or is accommodated in the adsorption-desorption chamber, so that the external dimensions of the freight container of the adsorption chamber module remain unchanged during transportation. Transportation in a freight container is easily possible if the adsorption fan module has suitable external dimensions compared to the openings of the freight container, so that, for example, the adsorption fan module can be pushed into the freight container after tilting through the lockable opening and removed on site. In this case, the adsorption fan module can be arranged together with the adsorber material in the adsorption-desorption chamber. However, the adsorber material can also be transported separately, since it must be easy to change the adsorber material due to the expected degradation over time and the freight container would therefore be transported unnecessarily “empty” in future scenarios.

### DRAWINGS

The invention is explained in more detail below using the attached drawings as examples. The figures show:

FIG. 1 a schematic representation of a CO2 adsorption device according to the prior art;

FIG. 2 a schematic representation of a modular CO2 adsorption device according to the invention, in a front view;

FIG. 3 a schematic representation of a modular CO2 adsorption device according to the invention in a perspective view; and

FIG. 4 a flow chart of a method for manufacturing an adsorption chamber module according to the invention.

FIG. 1 shows a CO2 adsorption device 10 for separating CO2 (carbon dioxide) according to the prior art.

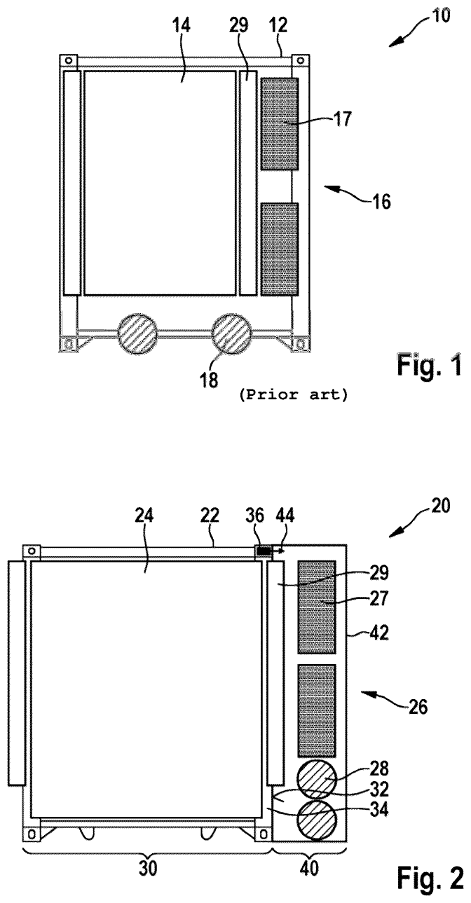

In comparison, FIG. 2 shows a modular CO2 adsorption device 20 according to the invention, which is also designed to separate CO2 (carbon dioxide) from an incoming air flow by means of a cyclic adsorption-desorption process.

The CO2 adsorption device 10 and the modular CO2 adsorption device 20 each have a freight container 12; 22, in which an adsorption-desorption chamber 14; 24 is arranged to receive an adsorbent (not shown) for adsorbing the CO2 from the supplied air flow.

The CO2 adsorption device 10 and the modular CO2 adsorption device 20 further each have a fan unit 16; 26 with fans 17; 27 for supplying the air flow into the respective adsorption-desorption chamber 14; 24 and a temperature control unit 18; 28 for controlling the temperature of the adsorbent for the adsorption-desorption process.

The CO2 adsorption device 10 and the modular CO2 adsorption device 20 also have closing elements 19; 29 for sealing the respective adsorption-desorption chamber 14; 24.

As can be seen from FIG. 1, in the state of the art CO2 adsorption device 10, the fans 17 of the fan unit 16 are arranged in the freight container 12, i.e. within the external dimensions or dimensions of the freight container 12. The same applies to the temperature control unit 18 and the closing elements 19. This severely limits the space available inside the freight container 12, particularly for the adsorption-desorption chamber 14.

In contrast to this, the CO2 adsorption device 20 according to the invention from FIG. 2 has a modular design and has an adsorption chamber module 30 and a separate adsorption fan module 40, which is releasably fastened to the outside of the freight container 22, i.e. outside the dimensions of the freight container 22 of the adsorption chamber module 30.

In detail, the voluminous fan unit 26 with the fans 27 has been “outsourced” from the freight container 22 into the external adsorption fan module 40 according to the invention or into a fan module housing 42 of the adsorption fan module 40, wherein the air flow can continue to be supplied by means of the fan unit 26 of the adsorption fan module 40 via an inlet duct (not shown) of the adsorption chamber module 30 into the adsorption-desorption chamber 24. The same applies to the temperature control unit 28 and one of the closing elements 29. This means that the space that has been freed up can be used to enlarge adsorption-desorption chamber 24.

Consequently, the adsorption chamber module 30 according to the invention only has the freight container 22 with the adsorption-desorption chamber 24, which now has a considerably larger volume due to the space that has been freed up compared to the adsorption-desorption chamber 14 according to the prior art from FIG. 1.

This ensures that the external dimensions of the freight container for transportation can be adhered to and, at the same time, the “outsourcing” the bulky fan unit 26 and the other units 28, 29 into the separate adsorption fan module 40—which can be releasably fastened on site (outside the main dimensions of ISO 668)—a much larger volume of the freight container 22 can be used as an adsorption-desorption chamber 24 for the adsorber material to be cycled.

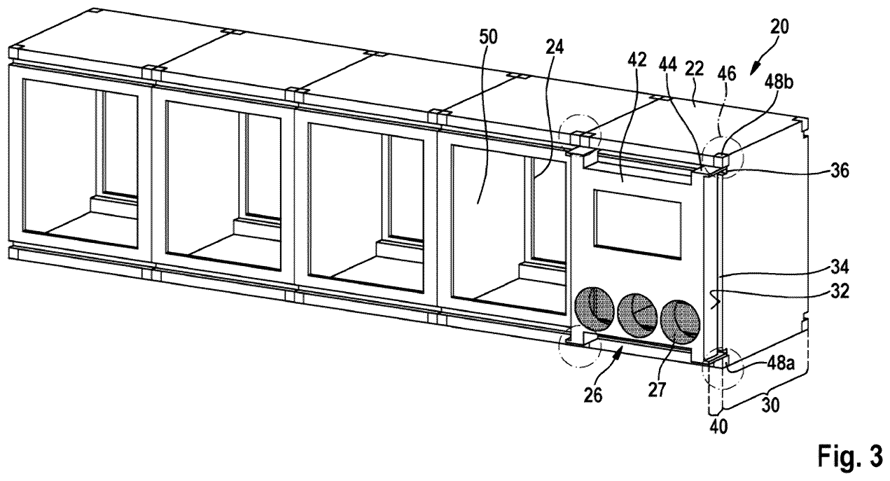

The freight container 22 has a receiving unit 36 on an outer side 32 of a lateral freight container outer wall 34 for the releasable fastening of the adsorption fan module 40 to the adsorption chamber module 30. Analogously, the fan module housing 42 of the adsorption fan module 40 has an engagement unit 44. The receiving unit 36 of the adsorption chamber module 30 and the engagement unit 44 of the adsorption fan module 40 are designed to form a releasable, form-fitting connection, which is explained in more detail in the description of FIG. 3 below.

FIG. 3 shows a schematic representation of a further modular CO2 adsorption device 20 according to the invention in a perspective view.

From this it can be seen, on the one hand, that the receiving unit 36 is arranged on one longitudinal side of the freight container 22, so that the at least one adsorption fan module 40 is releasably fastened to the longitudinal side. In this case, the receiving unit 36 on the outer side 32 of the longitudinal side of the freight container outer wall 34 has a load-receiving region 46 with two lower load-receiving points 48a, on which the adsorption fan module 40 is placed, and two upper load-receiving points 48b, on which the adsorption fan module 40 is fixed.

On the other hand, it can be seen that, due to the increased volume of the adsorption-desorption chamber 24, it is now suitable and designed to accommodate the adsorption fan module 40 for transport purposes, so that the external dimensions of the freight container 22 remain unchanged during transport. For this purpose, the adsorption-desorption chamber 24 has a correspondingly dimensioned, in particular lockable opening 50, through which the at least one adsorption fan module 40 can be introduced into the adsorption-desorption chamber 24 for transport and can be removed again for assembly and commissioning.

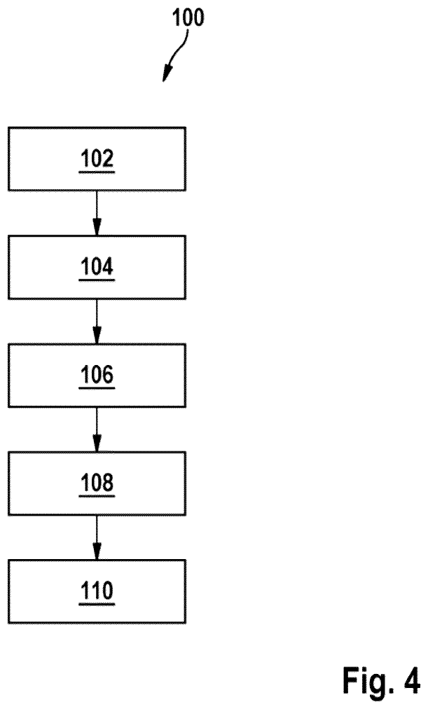

FIG. 4 shows a flow diagram of a method 100 for manufacturing an adsorption chamber module 30 for a modular CO2 adsorption device 20 for separating CO2 from a supplied air flow by means of an adsorption-desorption process. The method 100 comprises a step of providing 102 a freight container 22, which is in particular designed according to ISO 668, as a chamber module housing 22. The method 100 further comprises a step of forming 104 an adsorption-desorption chamber 24 in the freight container 22 for receiving an adsorbent for adsorbing the CO2 from the supplied air flow. The method 100 also comprises a step of forming 106 an inlet duct for supplying the air flow into the adsorption-desorption chamber 24. The method 100 further comprises a step of forming 108 an exhaust duct for discharging the CO2-reduced air flow out of the adsorption-desorption chamber 24. Finally, method 100 comprises a step of forming 110 a receiving unit 36 on the freight container 22 for the releasable fastening of at least one adsorption fan module 40 of the modular CO2 adsorption device 20 to an outer side 32 of a freight container outer wall 34, in order to guide the air flow by means of a fan unit 26 of the adsorption fan module 40 via the inlet duct into the adsorption-desorption chamber 24.

If an exemplary embodiment comprises an “and/or” conjunction between a first feature and a second feature, this is to be read such that the exemplary embodiment according to one embodiment comprises both the first feature and the second feature and according to a further embodiment comprises either only the first feature or only the second feature.

1. An adsorption chamber module for a modular CO2 adsorption device for separating CO2 from a supplied air flow by way of an adsorption-desorption process, comprising:
a freight container configured as a chamber module housing, which is designed according to ISO 668,
an adsorption-desorption chamber arranged in the freight container and configured to receive an adsorbent for adsorbing the CO2 from the supplied air flow,
an inlet duct configured to supply the air flow into the adsorption-desorption chamber, and
an outlet duct configured to discharge the CO2-reduced air flow from the adsorption-desorption chamber,
wherein the freight container has a receiving unit which is configured to releasably fasten at least one adsorption fan module of the modular CO2 adsorption device to an outer side of a freight container outer wall to guide the air flow by way of a fan unit of the adsorption fan module via the inlet duct into the adsorption-desorption chamber.

2. The adsorption chamber module according to claim 1, wherein the receiving unit is designed for the releasable fastening to enter into a releasable form-fitting connection with an engagement unit of the at least one adsorption fan module.

3. The adsorption chamber module according to claim 1, wherein the receiving unit on the outer side of the freight container outer wall has at least one load-receiving region to and/or on which the at least one adsorption fan module is hooked and/or placed and/or fixed for releasable fastening.

4. The adsorption chamber module according to claim 3, wherein the load-receiving region has at least one lower load-receiving point on which the adsorption fan module is placed, and/or has at least one upper load-receiving point on which the adsorption fan module is fixed.

5. The adsorption chamber module according to claim 1, wherein the receiving unit has at least one bearing element for rotatable and/or pivotable and/or slidable mounting of the at least one adsorption fan module on the outer side of the freight container outer wall.

6. The adsorption chamber module according to claim 1, wherein the receiving unit is arranged on at least one transverse side of the freight container and/or at least one longitudinal side of the freight container, so that the at least one adsorption fan module is releasably fastened on the respective side.

7. The adsorption chamber module according to claim 1, wherein the adsorption-desorption chamber is configured to accommodate the at least one adsorption fan module for transport purposes, such that the external dimensions of the freight container are unchanged during transport.

8. The adsorption chamber module according to claim 7, wherein the adsorption-desorption chamber has an appropriately dimensioned, lockable opening, through which the at least one adsorption fan module can be introduced into the adsorption-desorption chamber and removed from it again.

9. The adsorption chamber module according to claim 1, further comprising at least one fluidic connection for the fluidic attachment of a fan unit of the at least one adsorption fan module to the inlet duct of the adsorption chamber module and/or a temperature control unit of the at least one adsorption fan module to a temperature control line of the adsorption chamber module and/or a pump unit of the at least one adsorption fan module to a pressure connection of the adsorption chamber module for the desorption process.

10. The adsorption chamber module according to claim 1, further comprising an electrical plug-in connection for the electrical connection of the at least one adsorption fan module that can be fastened or is fastened releasably.

11. An adsorption fan module for a modular CO2 adsorption device for separating CO2 from a supplied air flow by way of an adsorption-desorption process, comprising:
a fan module housing, and
a fan unit arranged in the fan module housing and configured to supply the air flow into an adsorption-desorption chamber for receiving an adsorbent for adsorption of the CO2 from the supplied air flow, wherein the adsorption-desorption chamber is arranged in a freight container, according to ISO 668, of an adsorption chamber module of the modular CO2 adsorption device,
wherein the fan module housing comprises an engagement unit for the releasable fastening the adsorption fan module to an outer side of a freight container outer wall of the freight container to direct the air flow by way of the fan unit via an inlet duct of the adsorption chamber module into the adsorption-desorption chamber.

12. The adsorption fan module according to claim 11, wherein the engagement unit is designed for releasable fastening, to enter into a releasable, form-fitting connection with a receiving unit of the adsorption chamber module.

13. The adsorption fan module according to claim 11, wherein the engagement unit is designed for the releasable fastening, to be hung on and/or placed on and/or fixed on the outer side of the freight container outer wall on at least one load-receiving region.

14. The adsorption fan module according to claim 13, wherein the engagement unit is designed for the releasable fastening, in that it is placed on at least one lower load-receiving point of the load-receiving region and/or to be fixed to at least one upper load-receiving point of the load-receiving region.

15. The adsorption fan module according to claim 11, wherein the engagement unit has at least one bearing element for rotatable and/or pivotable and/or slidable mounting on the outer side of the freight container outer wall.

16. The adsorption fan module according to claim 11, further comprising at least one of the following units, which is/are arranged in and/or on the fan module housing: a temperature control unit for controlling the temperature of the adsorbent for the adsorption-desorption process; a pump unit for providing an overpressure and/or underpressure for the desorption process; a closing unit for opening and/or closing the inlet duct and/or the outlet duct; a drive unit for closing elements of a closing unit; a sensor unit for the adsorption-desorption process; a control unit for controlling and/or regulating the adsorption-desorption process; an energy supply unit and/or energy generation unit for the adsorption-desorption process.

17. The adsorption fan module according to claim 11, further comprising at least one fluid connection for fluidic attachment of the fan unit to the inlet duct of the adsorption chamber module and/or the temperature control unit to a temperature control line of the adsorption chamber module and/or the pump unit to a pressure connection of the adsorption chamber module for the desorption process.

18. The adsorption fan module according to claim 11, further comprising an electrical plug-in connection for electrical connection to the adsorption chamber module.

19. A modular CO2 adsorption device for separating CO2 from a supplied air flow by way of an adsorption-desorption process, comprising an adsorption chamber module according to claim 1, and at least one adsorption fan module.

20. The modular CO2 adsorption device according to claim 19, wherein the at least one adsorption fan module is releasably fastened on the outer side of the freight container outer wall of the freight container of the adsorption chamber module or is accommodated in the adsorption-desorption chamber, so that the external dimensions of the freight container of the adsorption chamber module remain unchanged during transportation.

21. Use of an adsorption chamber module according to claim 1 for separating CO2 from a supplied air flow.

22. A method for producing an adsorption chamber module for a modular CO2 adsorption device for separating CO2 from a supplied air flow by way of an adsorption-desorption process according to claim 1, comprising:
providing a freight container, which is designed according to ISO 668, as a chamber module housing,
forming an adsorption-desorption chamber in the freight container for receiving an adsorbent for adsorbing the CO2 from the supplied air flow,
forming an inlet duct for supplying the air flow into the adsorption-desorption chamber,
forming an outlet duct for discharging the CO2-reduced air flow from the adsorption-desorption chamber, and
forming a receiving unit on the freight container for the releasable fastening of at least one adsorption fan module of the modular CO2 adsorption device on an outer side of a freight container outer wall, to direct the air flow via the inlet duct into the adsorption-desorption chamber by way of a fan unit of the adsorption fan module.

23. A method for transporting a modular CO2 adsorption device for separating CO2 from a supplied air flow by way of an adsorption-desorption process according to claim 19, wherein the at least one adsorption fan module is arranged in the adsorption-desorption chamber for transport purposes, so that the external dimensions of the freight container of the adsorption chamber module remain unchanged during transport.
